(19) United States
(12) Patent Application Publication
(10) Pub. No.: US 2025/0052906 A1
(43) Pub. Date: Feb. 13, 2025

(54) LIDAR HAVING WAVELENGTH LOCKING FUNCTION

(71) Applicant: Mitsubishi Electric Corporation, Tokyo (JP)

(72) Inventors: Hidenobu TSUJI, Tokyo (JP); Shumpei KAMEYAMA, Tokyo (JP)

(73) Assignee: Mitsubishi Electric Corporation, Tokyo (JP)

(21) Appl. No.: 18/929,978

(22) Filed: Oct. 29, 2024

Related U.S. Application Data
(63) Continuation of application No. PCT/JP2022/024440, filed on Jun. 20, 2022.

(51) Int. Cl. G01S 17/95; G01S 7/481; G01S 7/497

(52) U.S. Cl. CPC G01S 17/95; G01S 7/4814; G01S 7/497

(57) ABSTRACT

A LIDAR according to the technology of the present disclosure includes: a laser light source to oscillate laser light; a beam splitter to split the laser light into two systems; a modulator to modulate a phase of the laser light sent from the beam splitter; a gas cell; a photodetector to detect transmitted laser light having transmitted through the gas cell, and convert the transmitted laser light into an electrical signal; and a wavelength controller to control a wavelength of the laser light source, the laser light source is temperature-controllable, and the LiDAR further includes a target spectrum detector to perform temperature sweep control and constant temperature control on the laser light source.

### CROSS REFERENCE TO RELATED APPLICATION

This application is a Continuation of PCT International Application No. PCT/JP2022/024440, filed on Jun. 20, 2022, which is hereby expressly incorporated by reference into the present application.

### TECHNICAL FIELD

The technology of the present disclosure relates to a LiDAR having a wavelength locking function.

### BACKGROUND ART

A wavelength locking function is used in, for example, a device that radiates laser light and performs various measurement. Examples of the device that radiates laser light and performs various measurement include Light Detection and Ranging or Laser Imaging Detection and Ranging (LiDAR).

For example, Non-Patent Literature 1 discloses a technology that simultaneously measures a water vapor density and a wind speed using a coherent Differential Absorption LiDAR (DIAL) whose wavelength is 1.53 [μm].

The differential absorption LiDAR according to Non-Patent Literature 1 includes a laser light source that outputs laser light having the same wavelength as a wavelength (λ_{ON}) that is absorbed in molecules in the atmosphere, and a laser light source that outputs laser light having the same wavelength as a wavelength (λ_{OFF}) that is not absorbed in the molecules in the atmosphere. The differential absorption LiDAR according to Non-Patent Literature 1 uses a wavelength locking circuit that fixes a wavelength to a certain target value for the laser light source that outputs the laser light having the wavelength (AON).

The differential absorption LiDAR according to Non-Patent Literature 1 adopts an HCN gas cell for the purpose of obtaining information on a wavelength that serves as an absolute reference. The differential absorption LiDAR according to Non-Patent Literature 1 irradiates a gas (HCN) of the gas cell with the laser light, and generates a feedback signal for wavelength locking from information on an absorption line spectrum obtained from transmitted light.

### CITATION LIST

### Non-Patent Literature

Non-Patent Literature 1: M. IMAKI et al., Optics Express 28 (18) 27078-27096, Aug. 31, 2020.

### SUMMARY OF INVENTION

### Technical Problem

When the absorption line spectrum of the HCN gas is measured, there are spectrum peaks (hereinafter, each will be referred to as an “absorption line spectrum peak”) that indicate approximately 50 absorption lines in a range of the wavelength from 1525 [nm] to 1565 [nm] (see FIG. 5).

A LIDAR that simultaneously measures the water vapor density and the wind speed needs to correctly select an absorption line of a specific wavelength such as an absorption line whose wavelength is 1531.276 [nm] among the absorption line spectrum peaks as the wavelength of the laser light, and generate a feedback signal for wavelength locking.

A LIDAR that simultaneously measures a water vapor density and a wind speed may cause a situation that, when a laser oscillator is unstable at, for example, a time immediately after the LiDAR is powered on, a wrong absorption line among absorption line spectrum peaks is selected even when a gas cell is used, and the wavelength of laser light is locked at an unintended wavelength.

### Solution to Problem

A LIDAR according to the technology of the present disclosure includes: a laser light source to oscillate laser light; a beam splitter to split the laser light into two systems; a modulator to modulate a phase of the laser light sent from the beam splitter; a gas cell; a photodetector to detect transmitted laser light having transmitted through the gas cell, and convert the transmitted laser light into an electrical signal; and a wavelength controller to control a wavelength of the laser light source by current control loop, the laser light source is temperature-controllable, and the LiDAR further includes a target spectrum detector to perform temperature sweep control and constant temperature control on the laser light source. In the temperature sweep control, the target spectrum detector sweeps the temperature, determines the wavelength of the spectral peak with the lowest transmittance, determines the wavelength of the spectral peak, where the wavelength is in the side where wavelength get shorter and is the target to be tuned, sets the temperature corresponding to the wavelength of the spectral peak to be tuned, and then, performs the constant temperature control.

### Advantageous Effects of Invention

The LiDAR having the wavelength locking function according to the technology of the present disclosure employs the above configuration, and consequently prevents a situation that a wrong absorption line among absorption line spectrum peaks is selected, and the wavelength of laser light is locked at an unintended wavelength.

### BRIEF DESCRIPTION OF DRAWINGS

FIG. 1 is a block diagram illustrating a functional configuration of a LiDAR having a wavelength locking function according to Embodiment 1.

FIG. 2 is a flowchart illustrating processing steps performed by the LiDAR having the wavelength locking function according to Embodiment 1.

FIG. 3 is a block diagram illustrating a functional configuration of a LiDAR having a wavelength locking function according to Embodiment 2.

FIG. 4 is a flowchart illustrating detailed steps of main processing (performed by the LiDAR having the wavelength locking function according to Embodiment 2.

FIG. 5 shows a graph showing an absorption line spectrum of an HCN gas.

FIG. 6A and FIG. 6B are graphs (FIG. 6A: wavelength versus temperature and FIG. 6B: wavelength versus injection current) showing wavelength characteristics of a DFB laser.

FIG. 7 is an explanatory view for describing a feedback signal used by a wavelength locking circuit for a current control loop.

### DESCRIPTION OF EMBODIMENTS

### Specification Required For Technology of Present Disclosure

Among system parameters disclosed in Non-Patent Literature 1, a wavelength (λ_{ON}) that is absorbed in molecules in the atmosphere is 1531.3814 [nm], and a wavelength (λ_{OFF}) that is not absorbed in the molecules in the atmosphere is 1531. 5537 [nm]. That is, accuracy of the wavelength of the specification required for the technology of the present disclosure is on an order of 0.001 [nm]. This accuracy is one hundredth compared to accuracy of a wavelength required for a technical field of so-called gas sensing, more specifically, accuracy on the order of 0.1 [nm].

Note that a device that implements measurement of a wavelength on the order of 0.001 [nm] includes a Michelson interferometer. In this regard, a device that is based on the Michelson interferometer has a larger device size inevitably in terms of the principal thereof, and therefore is not studied in this description.

### Embodiment 1

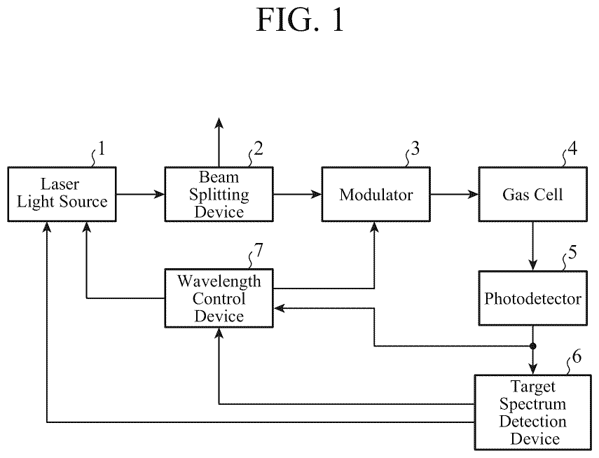

FIG. 1 is a block diagram illustrating a functional configuration of a LiDAR having a wavelength locking function according to Embodiment 1. As illustrated in FIG. 1, the LiDAR having the wavelength locking function according to Embodiment 1 includes a laser light source 1, a beam splitting device 2, a modulator 3, a gas cell 4, a photodetector 5, a target spectrum detection device 6, and a wavelength control device 7.

### Laser Light Source 1

The laser light source 1 may be implemented as a Distributed FeedBack laser (DFB laser) having a wavelength range including 1.53 [μm]. Generally, the DFB laser has very high wavelength stability, oscillates in a single mode, and has a very narrow line width. Hence, the DFB laser is suitable as a light source for the LiDAR having the wavelength locking function. In this regard, the DFB laser also has an oscillation wavelength that changes depending on a current to be injected (hereinafter referred to as an “injection current”) and an environmental temperature.

The laser light source 1 according to the technology of the present disclosure is temperature-controllable using a signal from outside. More specifically, the laser light source 1 according to the technology of the present disclosure may be implemented as a DFB laser that includes, for example, Thermo-Electric Cooling (TEC), that is, a Peltier element of a micro size, and includes a terminal for TEC.

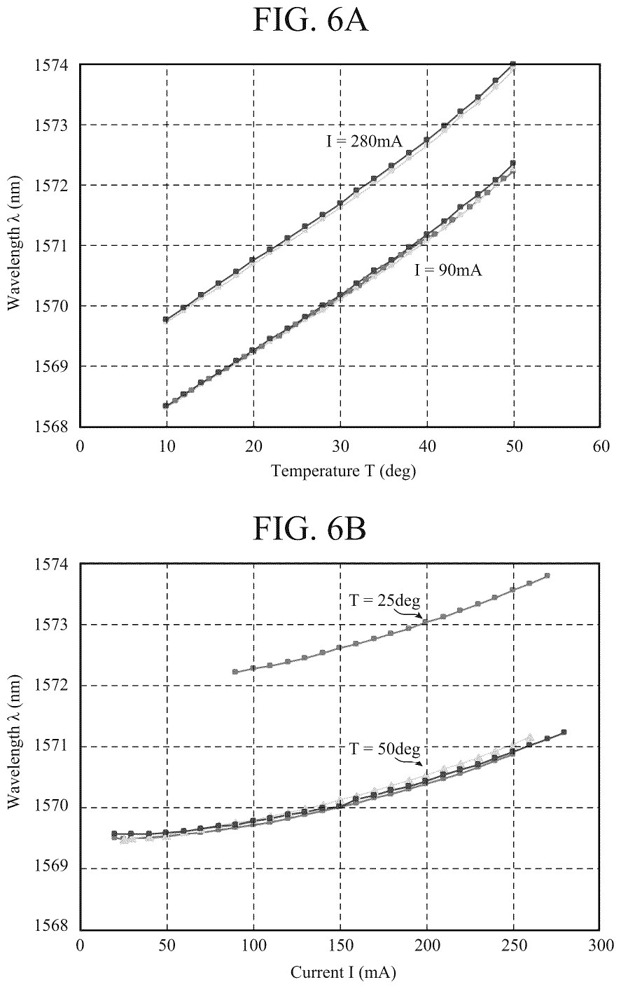

FIG. 6A and FIG. 6B are graphs (FIG. 6A: wavelength versus temperature and FIG. 6B: wavelength versus injection current) showing wavelength characteristics of the DFB laser. As shown in FIG. 6A, as the temperature rises in the DFB laser, the wavelength of laser light to be radiated becomes long. Furthermore, as shown in the FIG. 6B, as the injection current increases in the DFB laser, the wavelength of laser light to be radiated becomes long.

The laser light generated by the laser light source 1 is sent to the beam splitting device 2.

### Beam Splitting Device 2

The beam splitting device 2 is a component that splits the sent laser light to two systems.

One of the beams of laser light split by the beam splitting device 2 is sent to the modulator 3.

### Modulator 3

The modulator 3 is a component that modulates the phase of sent laser light. The modulator 3 starts modulating the phase when receiving input of a modulation start signal. When the modulation start signal is not input, the modulator 3 outputs the sent laser light without processing the laser light.

### Gas Cell 4

As described above, the gas cell 4 is a component that obtains information on a wavelength that serves as an absolute reference. Specifically, as the gas cell 4 according to the technology of the present disclosure, the HCN gas cell 4 whose medium is Hydrogen CyaNide (HCN) gas is used.

A reason why an absorption line of H₂O is not used and an absorption line of HCN is used when a measurement target is a water vapor density is that an absorption rate of H₂O is small. If the gas cell 4 is implemented by using water vapor as the medium, the gas cell 4 would have the same scale size as that of an observation field, and is not realistic.

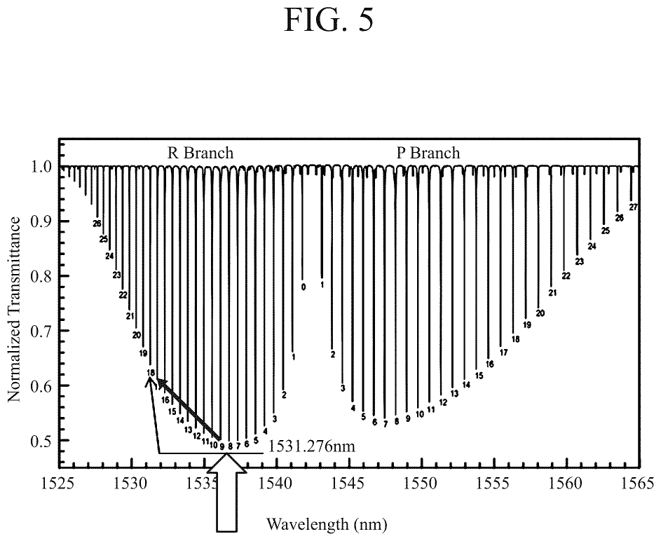

FIG. 5 shows a graph showing an absorption line spectrum of the HCN gas. In the graph shown in FIG. 5, the vertical axis indicates a normalized transmittance, and the horizontal axis indicates a wavelength. As shown in FIG. 5, when the absorption line spectrum of the HCN gas is observed, there are absorption line spectrum peaks that indicate approximately 50 absorption lines in a range of the wavelength from 1525 [nm] to 1565 [nm].

Laser light (hereinafter referred to as “transmitted laser light”) that has transmitted through the gas cell 4 and whose specific spectrum has been absorbed is sent to the photodetector 5.

### Photodetector 5

The photodetector 5 is a component that detects the sent transmitted laser light and converts the transmitted laser light into an electrical signal. The electrical signal generated by the photodetector 5 is sent to the target spectrum detection device 6 and the wavelength control device 7.

### Target Spectrum Detection Device 6

The target spectrum detection device 6 is a component that is not provided in conventional LiDAR devices and is unique to the technology of the present disclosure. The target spectrum detection device 6 performs roughly two types of temperature control. First temperature control is control (hereinafter referred to as “temperature sweep control”) of sweeping the temperature of the laser light source 1. Second temperature control is control (hereinafter referred to as “constant temperature control”) of constantly keeping the temperature of the laser light source 1.

Temperature sweep performed by the target spectrum detection device 6 during the first temperature control is, after powering on, to raise the temperature of the TEC of the laser light source 1 from 0[° C.] to 60[° C.] at a speed of 6 to 60[° C./min] once, and then drop the temperature of the TEC of the laser light source 1 from 60[° C.] to 0[° C.] at a speed of 6 to 60[° C./min].

The two types of temperature control performed by the target spectrum detection device 6 is implemented by inputting a control signal to the TEC terminal of the laser light source 1. In the block diagram illustrated in FIG. 1, a loop of the laser light source 1→the beam splitting device 2→the modulator 3→the gas cell 4→the photodetector 5→the target spectrum detection device 6→the laser light source 1 indicates a temperature control loop.

Details of processing steps processed by the target spectrum detection device 6 will be made more apparent from description to be described later.

### Wavelength Control Device 7

The wavelength control device 7 is a component that controls the wavelength of the laser light source 1. More specifically, the wavelength control device 7 controls the wavelength of the laser light source 1 by controlling the injection current to be injected to the laser light source 1. In the block diagram illustrated in FIG. 1, the loop of the laser light source 1→the beam splitting device 2→the modulator 3→the gas cell 4→the photodetector 5→the wavelength control device 7→the laser light source 1 indicates a current control loop.

The above-described temperature control functions to roughly adjust the wavelength. By contrast with this, the current control loop functions to finely adjust the wavelength.

### Processing Contents of LiDAR Having Wavelength Locking Function according to Embodiment 1

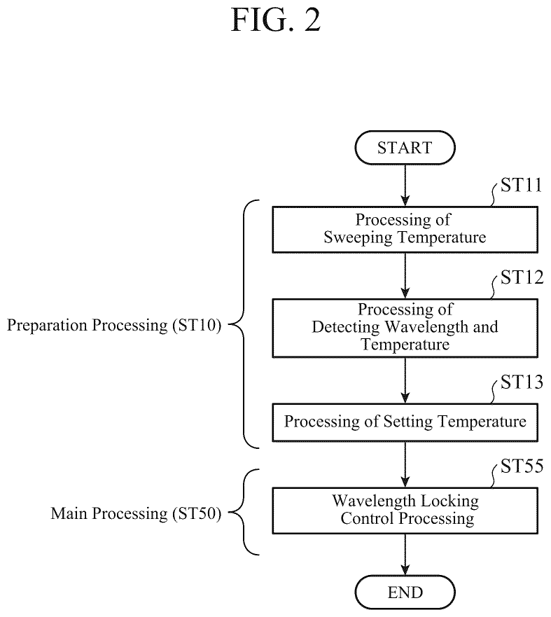

FIG. 2 is a flowchart illustrating processing steps performed by the LiDAR having the wavelength locking function according to Embodiment 1.

As illustrated in FIG. 2, the processing steps performed by the LiDAR having the wavelength locking function according to Embodiment 1 include preparation processing (ST10) and main processing (ST50). An operation implemented by the preparation processing (ST10) has a purpose of stabilizing an output of the laser light source 1, and is similar to a warm-up operation.

The preparation processing (ST10) includes processing (ST11) of sweeping a temperature, processing (ST12) of detecting the wavelength and the temperature, and processing (ST13) of setting the temperature. In the preparation processing (ST10), the wavelength control device 7 does not control the current control loop. The injection current to the laser light source 1 is set to a predetermined value, more specifically, a certain value that is from 90 [mA] to 280 [mA] and serves as a reference. How to determine an injection current amount that serves as the reference (hereinafter referred to as a “reference injection current amount) will be made more apparent from description to be described later.

Furthermore, the main processing (ST50) includes at least wavelength locking control processing (ST55). In the wavelength locking control processing (ST55), the wavelength control device 7 controls the current control loop for the first time.

The processing (ST11) of sweeping the temperature is a processing step performed by the target spectrum detection device 6. In the processing (ST11) of sweeping the temperature, the target spectrum detection device 6 performs the above-described temperature sweep control on the laser light source 1. As described above, as the temperature rises in the DFB laser, the wavelength of laser light to be radiated becomes long. More specifically, as shown in the left graph in FIG. 6, as the temperature (T) rises 10[° C.] in the DFB laser, the wavelength increases by approximately 1 [nm].

As described above, FIG. 5 shows a graph showing the absorption line spectrum of the HCN gas. The absorption line spectrum shown in FIG. 5 is classified into a distribution on the left side of the graph (a distribution from 1525 [nm] to 1542 [nm] indicated as “R Branch” in FIG. 5), and a distribution on the right side of the graph (a distribution from 1543 [nm] to 1565 [nm] indicated as “P Branch” in FIG. 5). There are absorption line spectrum peaks that are assigned numbers of 0 to 26 in R Branch. There are absorption line spectrum peaks that are assigned numbers of 1 to 27 in P Branch.

An absorption line spectrum peak (hereinafter referred to as an “18th absorption line spectrum peak”) that is assigned number 18 in R Branch is a peak whose wavelength that needs to be tuned at this time is 1531.276 [nm]. Furthermore, an absorption line spectrum peak (hereinafter referred to as a “ninth absorption line spectrum peak”) that is assigned number 9 in R Branch is a peak at which the transmittance is the lowest among all peaks, and is a peak whose wavelength is approximately 1536 [nm].

In the processing (ST11) of sweeping the temperature, the target spectrum detection device 6 sweeps the wavelength of the laser light radiated by the laser light source 1 within a range including both of the wavelength of the ninth absorption line spectrum peak and the wavelength of the 18th absorption line spectrum peak. Assuming that the temperature (T) at which temperature sweep can be performed is 0[° C.] to 60[° C.], a change range of the wavelength of the laser light source 1 is approximately 6 [nm]. Calculating the change range backward, the reference injection current amount for the laser light source 1 is preferably determined as approximately 1531 [nm] when the temperature (T) of the laser light source 1 is 0[° C.]. By determining the reference injection current amount in this way, the wavelength of the laser light is approximately 1537 [nm] when the temperature (T) of the laser light source 1 is 60[° C.]. The range of this temperature sweep for sweeping the wavelength also includes the wavelength of an eighteenth absorption line spectrum peak that has a much longer wavelength than that of the ninth absorption line spectrum peak.

The processing (ST12) of detecting the wavelength and the temperature is a processing step performed by the target spectrum detection device 6. In the processing (ST12) of detecting the wavelength and the temperature, the target spectrum detection device 6 simultaneously detects the wavelength and the temperature of the laser light source 1 while performing temperature sweep control on the laser light source 1. In this regard, detection of the wavelength of the laser light source 1 performed in the processing (ST12) of detecting the wavelength and the temperature is based on information on the absorption line spectrum of the HCN gas.

The LiDAR having the wavelength locking function according to the technology of the present disclosure converts information on the absorption line spectrum of the HCN gas shown in FIG. 5 into, for example, a data table to hold. The LiDAR having the wavelength locking function according to the technology of the present disclosure holds this information, and consequently can monitor the strength of light (hereinafter referred to as “transmitted light strength”) having transmitted through the gas cell 4, determine that the peak of the lowest transmittance is the ninth absorption line spectrum peak, and determine that the 18th absorption line spectrum peak obtained by counting nine absorption line spectrum peaks from the ninth absorption line spectrum peak toward a shorter wavelength side is a peak whose wavelength that needs to be tuned at this time is 1531.276 [nm].

The processing (ST13) of setting the temperature is a processing step performed by the target spectrum detection device 6. In the processing (ST13) of setting the temperature, the target spectrum detection device 6 sets the temperature of the laser light source 1 to a temperature associated with the wavelength of the 18th absorption line spectrum peak obtained in the processing (ST12) of detecting the wavelength and the temperature. Note that, although the tuned wavelength is the wavelength (1531.276 [nm]) of the 18th absorption line spectrum peak in this description, the technology of the present disclosure is not limited to this. The wavelength that needs to be tuned may be determined as appropriate depending on a use purpose of the LiDAR.

The target spectrum detection device 6 performs constant temperature control on the laser light source 1, and sends a “control start signal” that triggers start of current control to the wavelength control device 7 after the temperature of the laser light source 1 is stabilized at the set temperature.

The wavelength locking control processing (ST55) is a processing step performed by the wavelength control device 7. The wavelength control device 7 that has received the control start signal starts current control of the current control loop. The wavelength control device 7 sends a “modulation start signal” that serves as a trigger to the modulator 3 at the same time as the time of start of current control of the current control loop.

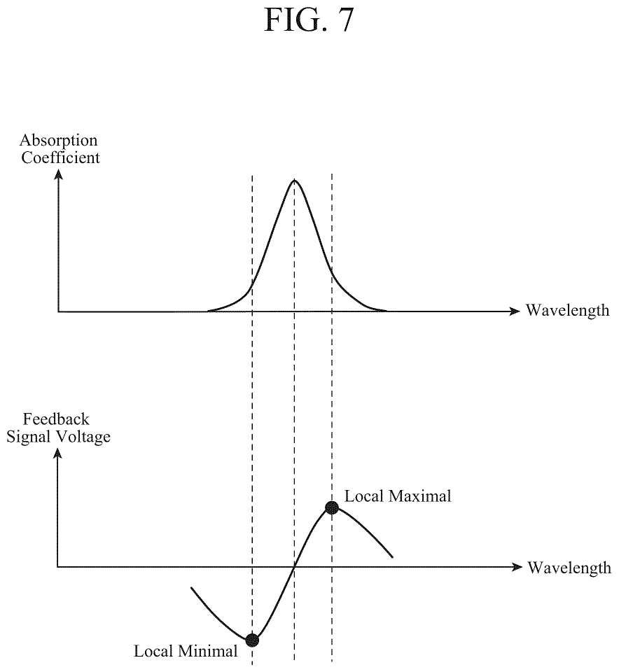

FIG. 7 is an explanatory view for describing a feedback signal used by the wavelength locking circuit for the current control loop. When the modulator 3 modulates the phase of the laser light, side-band waves appear on a plus side and a minus side of the center frequency of the laser light. The phases of the side-band waves that appear on the plus side and the minus side differ by 180 degrees. By correlating the laser light whose phase has been modulated and the transmitted light that has transmitted through the gas cell 4, it is possible to obtain a feedback signal shown in a graph in a lower part in FIG. 7. In the wavelength locking control processing (ST55), the wavelength control device 7 performs current control of the current control loop on the basis of this feedback signal.

### Modified Example of Detection of Wavelength of Target Spectrum Detection Device 6

In the processing (ST12) of detecting the wavelength and the temperature, the target spectrum detection device 6 finds the 18th absorption line spectrum peak by a method of counting nine peaks of the lowest transmittance from the ninth absorption line spectrum peak. However, if the transmittance of the laser light transmitting through the gas cell 4 is directly found, the target spectrum detection device 6 may directly find a wavelength of what number of an absorption line spectrum peak the peak corresponds to at a time of wavelength sweep.

The feedback signal is a signal that can be obtained by correlating the laser light that has the side-band wave and the transmitted light that has transmitted through the gas cell 4, so that it is possible to estimate the magnitude of the absorption line spectrum peak by calculating the magnitude of the feedback signal during wavelength sweep of temperature sweep such as a difference between a “local maximum” and a “local minimum” described in the graph in a lower part of FIG. 7.

In the processing (ST12) of detecting the wavelength and the temperature, the target spectrum detection device 6 may find the 18th absorption line spectrum peak by a method of estimating the magnitude of the absorption line spectrum peak on the basis of the magnitude of the feedback signal instead of the method of finding the 18th absorption line spectrum peak by counting the nine peaks of the lowest transmittance from the ninth absorption line spectrum peak.

When the wavelength is detected using the feedback signal, the modulator 3 needs to modulate the phase of the laser light at a stage of the preparation processing (ST10). In a case where this modification example is adopted, the modulator 3 modulates the phase at all times, and the “modulation start signal” that serves as a trigger is unnecessary.

As described above, the LiDAR according Embodiment 1 employs the above configuration, so that it is possible to prevent a situation that a wrong absorption line among absorption line spectrum peaks is selected, and the wavelength of laser light is locked at an unintended wavelength.

### Embodiment 2

A LIDAR having a wavelength locking function according to Embodiment 2 is a modification example of a LiDAR according to the technology of the present disclosure. More specifically, the LiDAR having the wavelength locking function according to Embodiment 2 is a LiDAR according to an aspect that is configured to embody main processing (ST50) according to the technology of the present disclosure. Unless clearly indicated in particular, the same reference numerals as those in Embodiment 1 will be used in Embodiment 2. Furthermore, Embodiment 2 will omit description that overlaps those in Embodiment 1 as appropriate.

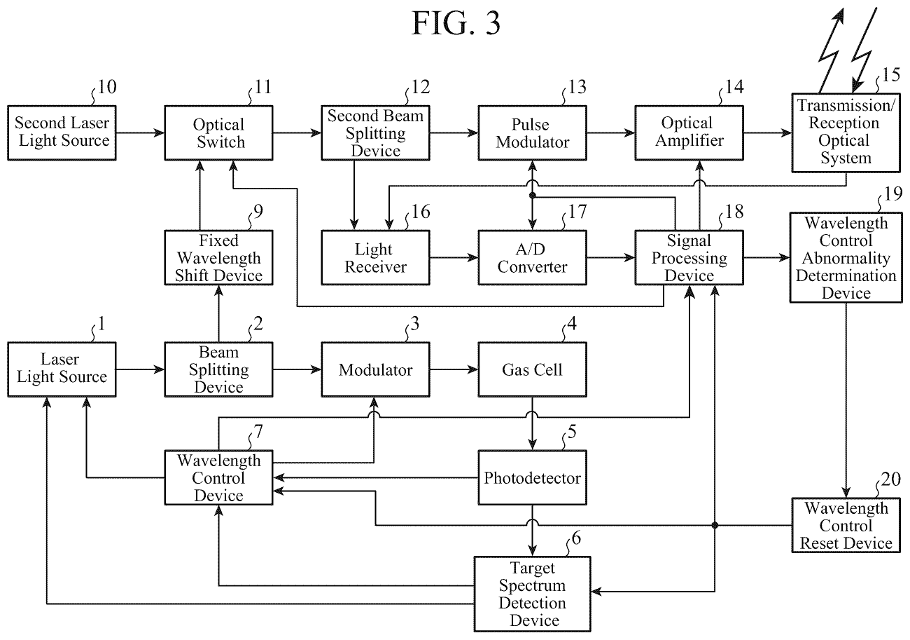

FIG. 3 is a block diagram illustrating a functional configuration of the LiDAR having the wavelength locking function according to Embodiment 2. As illustrated in FIG. 3, the LiDAR having the wavelength locking function according to Embodiment 2 includes a fixed wavelength shift device 9, a second laser light source 10, an optical switch 11, a second beam splitting device 12, a pulse modulator 13, an optical amplifier 14, a transmission/reception optical system 15, a light receiver 16, an A/D converter 17, a signal processing device 18, a wavelength control abnormality determination device 19, and a wavelength control reset device 20 in addition to components (see FIG. 1) described in Embodiment 1.

### Fixed Wavelength Shift Device 9

The fixed wavelength shift device 9 is a component that performs wavelength shift on the wavelength of input light by a preset fixed wavelength. More specifically, the fixed wavelength shift device 9 performs wavelength shift on the laser light sent from the beam splitting device 2 by the fixed wavelength, and converts the laser light into laser light having the same wavelength as the wavelength (λ_{ON}) that is absorbed in molecules in the atmosphere.

The wavelength of the laser light oscillated by the laser light source 1 is tuned to, for example, the wavelength of the 18th absorption line spectrum peak, and is 1531.276 [nm]. On the other hand, the wavelength (λ_{ON}) that is absorbed in molecules in the atmosphere is, for example, 1531.3814 [nm] described in Non-Patent Literature 1. In this case, the amount of wavelength shift performed by the fixed wavelength shift device 9 is 0.1054 [nm].

### Second Laser Light Source 10

The second laser light source 10 is a component that oscillates laser light having the same wavelength as the wavelength (λ_{OFF}) that is not absorbed in molecules in the atmosphere.

The wavelength (λ_{OFF}) of the laser light oscillated by the second laser light source 10 is, for example, 1531.5537 [nm] described in Non-Patent Literature 1.

The laser light oscillated by the second laser light source 10 is sent to the optical switch 11.

### Optical Switch 11

The optical switch 11 is a component that switches a plurality of light routes and selectively outputs light in accordance with an input optical switch control signal. More specifically, by switching the routes, the optical switch 11 selectively outputs one of the laser light of the wavelength (λ_{ON}) that is absorbed in the molecules in the atmosphere and the laser light of the wavelength (λ_{OFF}) that is not absorbed in the molecules in the atmosphere.

The laser light selectively output by the optical switch 11 is sent to the second beam splitting device 12.

### Second Beam Splitting Device 12

The second beam splitting device 12 is a component that splits the input light at a predetermined power ratio to output. More specifically, the second beam splitting device 12 splits the laser light sent from the optical switch 11 into transmission laser light and reference laser light at the predetermined power ratio to output. Generally, the reference laser light may have less power than the transmission laser light.

The transmission laser light is sent to the pulse modulator 13. The reference laser light is sent to the light receiver 16.

### Pulse Modulator 13

The pulse modulator 13 is a component that pulses the input transmission laser light at a timing of a trigger signal from the signal processing device 18, and modulates the optical frequency of the transmission laser light at a predetermined set value.

The laser light pulsed and modulated by the pulse modulator 13 is sent to the optical amplifier 14.

### Optical Amplifier 14

The optical amplifier 14 is a component that amplifies and outputs the laser light sent from the pulse modulator 13.

The laser light amplified by the optical amplifier 14 is sent to the transmission/reception optical system 15.

### Transmission/Reception Optical System 15

The transmission/reception optical system 15 is a component that includes both of a transmission optical system that transmits light, and a reception optical system that receives light. The transmission optical system in the transmission/reception optical system 15 radiates the laser light sent from the optical amplifier 14 into the atmosphere. The light scattered and reflected by aerosol in the atmosphere is received by the reception optical system in the transmission/reception optical system 15, and is sent to the light receiver 16.

### Light Receiver 16

The light receiver 16 is a component that multiplexes the reference laser light sent from the second beam splitting device 12 and the reflection light sent from the transmission/reception optical system 15, and converts the multiplexed light into an analog electrical signal.

The analog electrical signal generated by the light receiver 16 is sent to the A/D converter 17.

### AD Converter 17

The A/D converter 17 is a component that converts the analog electrical signal sent from the light receiver 16 into a digital electrical signal. A timing of digital conversion performed by the A/D converter 17, that is, sampling complies with the trigger signal from the signal processing device 18.

The digital electrical signal generated by the A/D converter 17 is frequently referred to as a beat signal.

### Signal Processing Device 18

The signal processing device 18 is a component that performs various signal processing. The signal processing device 18 includes, for example, a signal processing circuit. Main processing performed by the signal processing device 18 is detection of the frequency (hereinafter referred to as a “beat signal frequency”) of the beat signal and the strength (hereinafter referred to as a “beat signal intensity”) of the beat signal. The signal processing device 18 further calculates a wind speed from the beat signal frequency, and calculates a molecular weight (hereinafter referred to as an “observation target molecular weight”) of an observation target from the beat signal intensity. Note that, strictly speaking, the wind speed calculated from the beat signal frequency is a wind speed of a laser radiation direction component.

The signal processing device 18 also generates a trigger signal for the pulse modulator 13 and a trigger signal for the A/D converter 17.

The signal processing device 18 receives a “stability control signal” that is a sign from the wavelength control device 7, and starts an operation. This “stability control signal” may be sent by the wavelength control device 7 to the signal processing device 18 when the magnitude of the feedback signal is smaller than a predetermined threshold for a certain period of time or more in the wavelength control device 7.

Furthermore, when receiving a reset signal from the wavelength control reset device 20, the signal processing device 18 stops the operation, and resets the state to an initial state.

Details of processing performed by the signal processing device 18 will be made more apparent from description to be described later.

The beat signal intensity and the observation target molecular weight calculated by the signal processing device 18 are sent to the wavelength control abnormality determination device 19.

### Wavelength Control Abnormality Determination Device 19

The wavelength control abnormality determination device 19 is a component that performs monitoring in such a way that wavelength control performed by the wavelength control device 7 does not become abnormal. In other words, the wavelength control abnormality determination device 19 determines whether or not the wavelength control performed by the wavelength control device 7 is abnormal. Abnormality determination performed by the wavelength control abnormality determination device 19 is performed on the basis of the beat signal intensity and the observation target molecular weight sent from the signal processing device 18. More specifically, the wavelength control abnormality determination device 19 determines that wavelength control is abnormal when the beat signal intensity exceeds a strength threshold and the observation target molecular weight goes below a molecular weight threshold.

When determining that wavelength control is abnormal, the wavelength control abnormality determination device 19 sends a “wavelength control abnormality signal” as a sign of the abnormality to the wavelength control reset device 20.

### Wavelength Control Reset Device 20

The wavelength control reset device 20 is a component that resets the target spectrum detection device 6, the wavelength control device 7, and the signal processing device 18 to initial states when the wavelength control abnormality determination device 19 transmits the wavelength control abnormality signal. The wavelength control reset device 20 may be configured to transmit the reset signal to each device to reset the target spectrum detection device 6, the wavelength control device 7, and the signal processing device 18.

### Processing Contents of LiDAR Having Wavelength Locking Function according to Embodiment 2

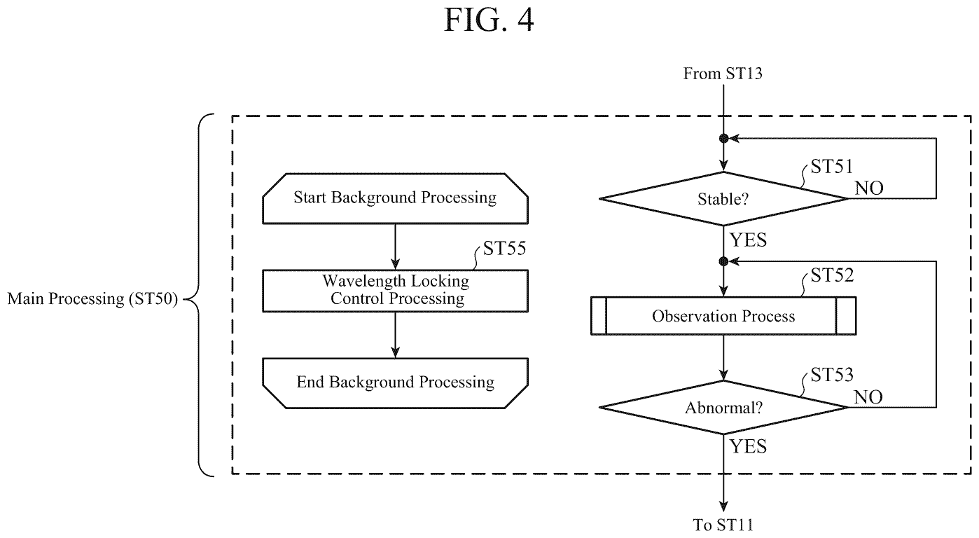

FIG. 4 is a flowchart illustrating detailed steps of main processing (ST50) performed by the LiDAR having the wavelength locking function according to Embodiment 2. As illustrated in FIG. 4, the main processing (ST50) includes stability determination processing (ST51), an observation process (ST52), abnormality determination processing (ST53), and wavelength locking control processing (ST55).

The stability determination processing (ST51) is a processing step performed by the wavelength control device 7. In the stability determination processing (ST51), the wavelength control device 7 determines whether or not the magnitude of the feedback signal is smaller than the predetermined threshold for the certain period of time or more. When the magnitude of the feedback signal is smaller than the predetermined threshold for the certain period of time or more, the wavelength control device 7 transmits the “stability control signal” as a sign to the signal processing device 18.

The observation process (ST52) is a processing step performed by the signal processing device 18. In the observation process (ST52), the signal processing device 18 detects the beat signal frequency and the beat signal intensity. The signal processing device 18 further calculates the wind speed from the beat signal frequency, and calculates an observation target molecular weight from the beat signal intensity. In the observation process (ST52), the signal processing device 18 also generates the trigger signal for the pulse modulator 13 and the trigger signal for the A/D converter 17.

The abnormality determination processing (ST53) is a processing step performed by the wavelength control abnormality determination device 19. In the abnormality determination processing (ST53), the wavelength control abnormality determination device 19 determines that wavelength control is abnormal when the beat signal intensity exceeds the strength threshold and the observation target molecular weight goes below the molecular weight threshold.

As described above, the LiDAR according to Embodiment 2 employs the above configuration, and consequently can simultaneously measure the water vapor density in the atmosphere and the wind speed while exhibiting the effect described in Embodiment 1.

### Industrial Applicability

The technology of the present disclosure can be applied to a measurement device that simultaneously measures a water vapor density in the atmosphere and a wind speed, and consequently has industrial applicability.

### Reference Signs List

1: laser light source, 2: beam splitting device (beam splitter), 3: modulator, 4: gas cell, 5: photodetector, 6: target spectrum detection device (target spectrum detector), 7: wavelength control device (wavelength controller), 9: fixed wavelength shift device, 10: second laser light source, 11: optical switch, 12: second beam splitting device, 13: pulse modulator, 14: optical amplifier, 15: transmission/reception optical system, 16: light receiver, 17: AD converter, 18: signal processing device (signal processor), 19: wavelength control abnormality determination device, 20: wavelength control reset device

What is claimed is:

1. A LiDAR comprising:
a laser light source to oscillate laser light;
a beam splitter to split the laser light into two systems;
a modulator to modulate a phase of the laser light sent from the beam splitter;
a gas cell;
a photodetector to detect transmitted laser light having transmitted through the gas cell, and convert the transmitted laser light into an electrical signal; and
a wavelength controller to control a wavelength of the laser light source by current control loop,
wherein,
the laser light source is temperature-controllable, and
the LiDAR further comprises a target spectrum detector to perform temperature sweep control and constant temperature control on the laser light source,
and wherein,
in the temperature sweep control, the target spectrum detector sweeps the temperature,
determines the wavelength of the spectral peak with the lowest transmittance,
determines the wavelength of the spectral peak, the wavelength being in the side where wavelength get shorter and being the target to be tuned,
sets the temperature corresponding to the wavelength of the spectral peak to be tuned,
and then, performs the constant temperature control.

2. A LIDAR comprising a laser light source to be able to control a temperature,
the LiDAR comprises a target spectrum detector to perform temperature sweep control and constant temperature control on the laser light source,
wherein,
as a consequence of the target spectrum detector performing temperature sweep control, and then, performing the constant temperature control,
the temperature of the laser light source rises from 0[° C.] to 60[° C.] at a speed of 6 to 60[° C./min] once, and then drops from 60[° C.] to 0[° C.] at a speed of 6 to 60[° C./min],
the temperature decreases from temperature-A to temperature-B and then becomes constant, temperature-A being the temperature corresponding to the peak with the lowest transmittance when the laser beam passes through the gas cell, temperature-B being the temperature corresponding to the wavelength of the spectral peak to be tuned.

3. The LiDAR according to claim 1, further comprising a signal processor to calculate a wind speed from a beat signal frequency, and calculate an observation target molecular weight from a beat signal intensity.
